(19) United States
(12) Patent Application Publication
(10) Pub. No.: US 2017/0357346 A1
(43) Pub. Date: Dec. 14, 2017

(54) TOUCH SCREEN AND PRESSURE TOUCH DETECTION METHOD

(71) Applicant: BOE TECHNOLOGY GROUP CO., LTD., Beijing (CN)

(72) Inventor: Xuefei WANG, Beijing (CN)

(21) Appl. No.: 15/521,209

(22) PCT Filed: Feb. 19, 2016
(86) PCT No.: PCT/CN2016/074097

§ 371 Date: Apr. 21, 2017

(30) Foreign Application Priority Data
Sep. 17, 2015 (CN) 201510596122.6

(51) Int. Cl. G06F 3/044; G06F 3/041

(52) U.S. Cl. CPC G06F 3/044; G06F 3/0412; G06F 3/0414; G06F 2203/04112; G06F 2203/04104

(57) ABSTRACT

The present disclosure provides a touch screen and a pressure touch detection method thereof. The touch screen comprises a touch panel and a frame surrounding sides of the touch panel, the touch panel comprises a display module and a touch module, at least one pressure sensor is arranged between the touch module and the frame; wherein the pressure sensor comprises a first electrode, a second electrode, and a piezoresistive material layer disposed between the first electrode and the second electrode; the first electrode is located on a same layer and is formed by a same material as a touch electrode of the touch module; the second electrode is formed by a portion of the frame in touch with the piezoresistive material layer and located at the opposite side of the first electrode; both the first electrode and the second electrode are connected with a touch control chip.

### FIELD OF THE INVENTION

The present invention relates to the technical field of display technology, and in particular to a touch screen and a pressure touch detection method used for the touch screen.

### BACKGROUND OF THE INVENTION

Touch screen has become main human-machine interface in personal mobile communication device and integrated information terminal, such as tablet computer, intelligent mobile phone and notebook computer, due to its advantages of easy operability, intuition and flexibility. Touch screens can be classified into four types according to the touch detection manner: resistive touch screen, capacitive touch screen, infrared touch screen and surface acoustic wave (SAW) touch screen. The capacitive touch screen has a function of multiple location touch, rapid response, long service life and high transmittance, therefore the user experience is superior. And as the process technology becomes mature gradually, the yield is greatly improved, the price of the capacitive screen keeps decreasing. Now the capacitive touch screen has become the dominant solution for touch interaction in information terminal of small and medium size.

One shortcoming of the capacitive touch screen is in that the capacitive touch screen is vulnerable to environmental interference, e.g. when gloves are worn, touching is performed by fingers with water, or the capacitive touch screen is used outdoors in rain, snow or the like, it is difficult to capture the touch accurately. Moreover, due to a high sensitivity of the capacitive touch screen, a touch may be wrongly treated to occur when a finger is left over the touch screen. Furthermore, capacitive touch screen only senses touch locations on the plane of the screen (a two-dimensional space having X, Y axis), but is not capable of sensing touch parameters along a direction perpendicular to the screen plane (Z axis).

### SUMMARY OF THE INVENTION

An object of the present invention is to overcome above technical problems by providing a touch screen and a pressure touch detection method for realizing three-dimensional multi-location touch control.

One solution of the present invention to overcome the above technical problems is a touch screen, comprising a touch panel and a frame surrounding sides of the touch panel, the touch panel comprises a display module and a touch module located at a light output side of the display module, the touch screen has a display area and a non-display area surrounding the display area, at least one pressure sensor is arranged between the touch module and the frame at the non-display area; wherein

the pressure sensor comprises a first electrode, a second electrode, and a piezoresistive material layer disposed between the first electrode and the second electrode; the first electrode is located on a same layer and is formed by a same material as a touch electrode of the touch module; the second electrode is formed by a portion of the frame in touch with the piezoresistive material layer and located at the opposite side of the first electrode; both the first electrode and the second electrode are connected with a touch control chip.

Optionally, the piezoresistive material layer is made of a composite piezoresistive material or a semiconductor piezoresistive material.

Optionally, the pressure sensor is connected to the frame through a double-sided conductive adhesive tape.

Optionally, the display module and the touch module are provided with optical adhesive therebetween for fixing the both modules.

Optionally, a pressure sensor is arranged at each corner of the touch screen.

Optionally, each of the pressure sensors is connected with a same touch control chip through a connecting wire.

Optionally, the first electrode is formed by indium tin oxide.

Optionally, the touch screen is used in any one of mobile phone, tablet computer and notebook computer.

One solution of the present invention to overcome the above technical problems is a pressure touch detection method for the touch screen, the pressure touch detection method comprises:

detecting a touch pressure according to change of a distance between the first electrode and the second electrode.

Optionally, the step of detecting a touch pressure according to change of a distance between the touch module and the frame at the non-display area comprises:

detecting resistance change of the piezoresistive material layer between the first electrode and the frame, calculating pressure data based on the resistance change to determine the touch pressure.

The solutions of the present disclosure are advantageous in that, in the touch screen of the present disclosure, at least one pressure sensor is arranged between the touch module and the frame at the non-display area, one terminal of the pressure sensor is connected with the frame (metal, as ground), the other terminal is connected with the first electrode, the first electrode and the frame are both connected to the touch control chip, the touch pressure can be detected by detecting change in the pressure sensor, wherein said touch pressure is a pressure along a direction perpendicular to the screen surface of the touch screen (i.e. Z axis of the touch screen), thereby the touch screen according to the embodiment of the present disclosure is capable of realizing three-dimensional (X, Y, Z axis) multi-location touch control. Furthermore, in the solutions of the present disclosure, the first electrode and the touch electrode are arranged in a same layer and are formed by a same material, therefore the first electrode and one of a driving electrode and a sensing electrode can be fabricated through a single patterning process, thereby reducing the fabrication cost.

### BRIEF DESCRIPTION OF THE DRAWINGS

FIG. 1 is a schematic view of a touch screen according to a first embodiment of the present disclosure;

FIG. 2 is a schematic view of a piezoresistive material for the touch screen according to the first embodiment of the present disclosure;

FIG. 3 is a schematic view illustrating the piezoresistive material of FIG. 2 being pressed;

FIG. 4 is a schematic view of connections between the touch screen and a touch control chip according to the first embodiment of the present disclosure;

FIG. 5 is a schematic view showing first electrodes and touch electrodes of the touch screen according to the first embodiment of the present disclosure.

### DETAILED DESCRIPTION OF THE EMBODIMENTS

In order to make a person skilled in the art to better understand the solutions of the present disclosure, the present invention will be described in detail below in conjunction with the accompanying drawings and detailed embodiments.

### First Embodiment

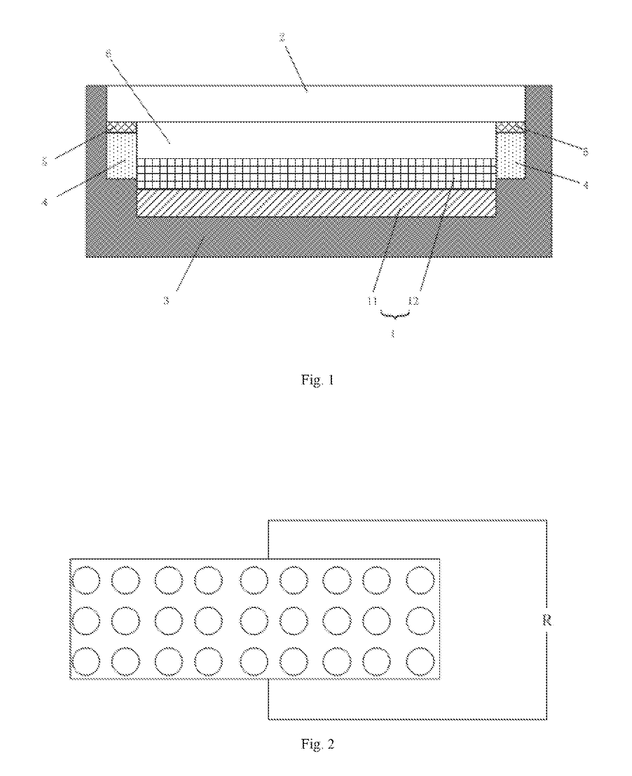

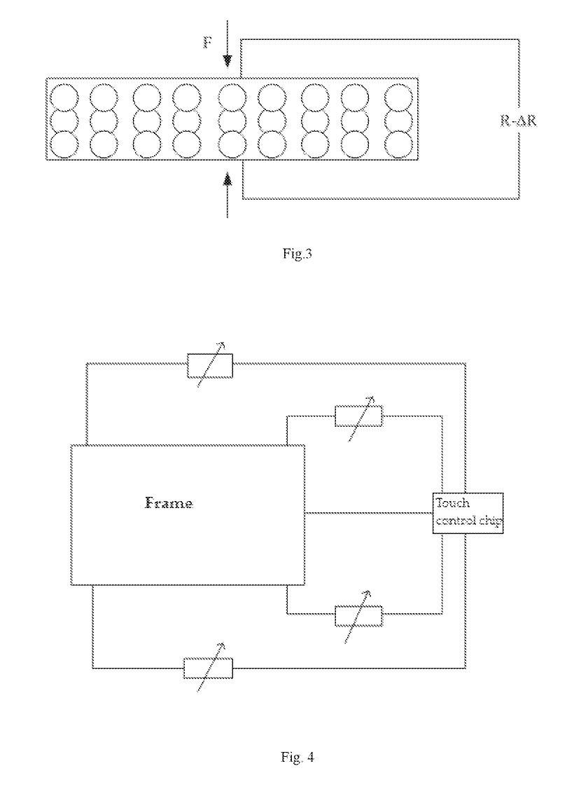

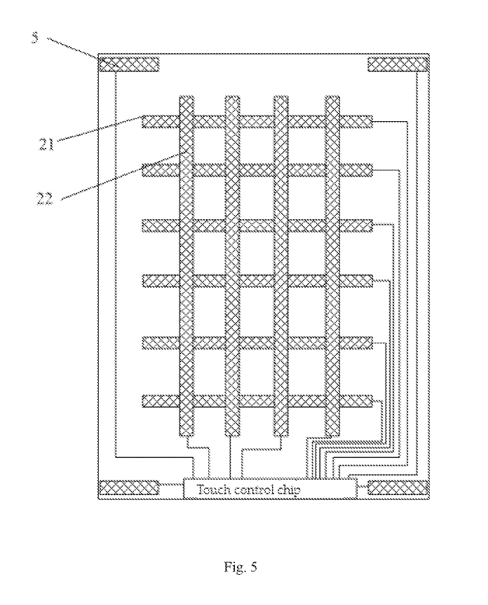

As shown in FIGS. 1 and 4, the present embodiment provides a touch screen, comprising a touch panel and a frame 3 surrounding sides of the touch panel, the touch panel comprises a display module 1 (comprising a backlight 11 and a display panel 12) and a touch module 2 located at a light output side of the display module 1, the touch screen has a display area and a non-display area surrounding the display area, at least one pressure sensor is arranged between the touch module 2 and the frame 3 at the non-display area; wherein the pressure sensor comprises a first electrode 5, a second electrode, and a piezoresistive material layer 4 (equivalent to a resistor) disposed between the first electrode 5 and the second electrode; the first electrode 5 is located on the same layer and is formed by same material as a touch electrode of the touch module; the second electrode is formed by a portion of the frame 3 in touch with the piezoresistive material layer 4 and is located at the opposite side of the first electrode 5; both the first electrode 5 and the second electrode are connected with a touch control chip.

The touch screen of the present embodiment has conventional multi-location capacitive touch screen at the display area, the capacitive touch screen using an OGS mode is a member for direct interaction with a user, the outer surface (light output surface) thereof is provided with rubbing resistant cover glass. Touch electrodes, including a plurality of driving electrodes 21 and sensing electrodes 22 arranged along X and Y axis respectively which are formed by transparent conductive material, are arranged on an inner surface of the cover glass, thereby forming an interaction capacitive matrix for detecting change of capacitance induced by human touch. In particular, in the present embodiment, at least one pressure sensor is arranged between the touch module 2 and the frame 3 at the non-display area, one terminal of the pressure sensor is connected with the frame 3 (metal, as ground), the other terminal is connected with the first electrode 5, the first electrode 5 and the frame 3 are both connected to the touch control chip, the touch pressure can be detected by detecting change in the pressure sensor, wherein said touch pressure is a pressure along a direction perpendicular to the screen surface of the touch screen (i.e. Z axis of the touch screen), thereby the touch screen according to the embodiment of the present disclosure is capable of realizing three dimension (X, Y, Z axis) multi-location touch control. Furthermore, in the present embodiment, the first electrode 5 and the touch electrode are arranged in a same layer and are formed by a same material, therefore the first electrode 5 and one of the driving electrodes 21 and the sensing electrodes 22 can be fabricated through a single patterning process, thereby reducing the fabrication costs.

Optionally, in the present embodiment, the piezoresistive material layer is made of a composite piezoresistive material or a semiconductor piezoresistive material. Specifically, as shown in FIGS. 2 and 3, the piezoresistive material is arranged between the first electrode 5 and the frame 3 (i.e. the second electrode). Taking a piezoresistive material layer formed by the composite piezoresistive material as an example, multiple conductive particles (small metal balls, graphene, carbon ball, silicon ball and the like) are contained in the piezoresistive material layer. The composite piezoresistive material may be conductive and has certain resistance R. When a pressure F is applied onto an electrode plate, the piezoresistive material will be pressed, the distance between two electrode plates is reduced and the distance among the internal conductive balls is reduced, thereby the resistance is decreased to be R-ΔR. The pressure can be detected by measuring change of the resistance between the electrodes.

Optionally, in the present embodiment, the pressure sensor is connected to the frame 3 through double-sided conductive adhesive tape, so as to fix the pressure sensor to the frame 3 without any gap.

Optionally, the display module 1 and the touch module 2 of the touch panel are provided with optical adhesive 6 (OCA adhesive) therebetween for fixing the both modules. The optical adhesive 6 is optically transparent with a high light transmittance.

In an embodiment as shown in FIG. 5, a pressure sensor is arranged at each of four corners of the touch screen; that is, the touch screen comprises four pressure sensors. Specifically, when an image on the touch screen is to be enlarged, a user touches the image by a finger or the like, and the four pressure sensors will be pressed. Since the four pressure sensors may be at different positions relative to the touch location, the pressures on the four pressure sensors will be different. In this way, the pressures applied to the four pressure sensors can be integrated to obtain a value, so as to enlarge the image. The larger the detected pressure is, the larger the image to be displayed is. Of course, the positions and the number of the pressure sensors are not limited to those in the present embodiment, more pressure sensors will be better, and however the sensors have to be arranged in consideration of cost and application requirements.

Optionally, the material of the first electrode 5 in the first embodiment may be InGaSnO. Other transparent conductive material such as IGZO, IZO, InSnO, Nano Silver, Graphene and carbon nano-tube may also be feasible. When the touch screen is a large size touch screen, the touch electrodes may have a metal grid structure.

The touch screen of the present embodiment is applicable to a touch display device of small size, such as anyone of mobile phone, tablet computer and notebook computer, and other display product.

### Second Embodiment

The present embodiment provides a pressure touch detection method for a touch screen, wherein the touch screen may be the touch screen of the first embodiment, the pressure touch detection method comprises:

detecting a touch pressure according to change of a distance between the first electrode 5 and the frame 3 (the second electrode).

Optionally, the piezoresistive material layer is made of a piezoresistive material, the step of detecting a touch pressure according to change of a distance between the first electrode 5 and the frame 3 (the second electrode) comprises:

detecting resistance change of the piezoresistive material layer between the first electrode 5 and the frame 3, calculating a pressure data based on the resistance change to determine the touch pressure.

According to the present embodiment, the touch pressure is detected using the piezoresistive sensor, such that the touch screen is provided with three-dimensional multi-location touch control function.

It could be understood that, the above embodiments are merely exemplary embodiments adopted for describing the principle of the present disclosure, but the present disclosure is not limited thereto. Various modifications and improvements may be made by a person skilled in the art without departing from the spirit and essence of the present disclosure, and these modifications and improvements are considered to be within the protection scope of the present disclosure.

1. A touch screen comprising a touch panel and a frame surrounding at least sides of the touch panel, wherein, the touch panel comprises a display module and a touch module located at a light output side of the display module, the touch screen has a display area and a non-display area surrounding the display area, at least one pressure sensor is arranged between the touch module and the frame at the non-display area;
the pressure sensor comprises a first electrode, a second electrode, and a piezoresistive material layer disposed between the first electrode and the second electrode; the first electrode is located on a same layer and is formed by a same material as a touch electrode of the touch module; the second electrode is formed by a portion of the frame in touch with the piezoresistive material layer and located at the opposite side of the first electrode; both the first electrode and the second electrode are connected with a touch control chip.

2. The touch screen of claim 1, wherein the piezoresistive material layer is made of a composite piezoresistive material or a semiconductor piezoresistive material.

3. The touch screen of claim 1, wherein the pressure sensor is connected to the frame through a double-sided conductive adhesive tape.

4. The touch screen of claim 1, wherein the display module and the touch module are provided with optical adhesive therebetween for fixing them.

5. The touch screen of claim 1, wherein a pressure sensor is arranged at each corner of the touch screen.

6. The touch screen of claim 5, wherein each of the pressure sensors is connected with a same touch control chip through a connecting wire.

7. The touch screen of claim 1, wherein the first electrode is formed by indium tin oxide.

8. The touch screen of claim 1, wherein the touch screen is used in any one of mobile phone, tablet computer and notebook computer.

9. A pressure touch detection method for the touch screen of claim 1, comprising:
detecting a touch pressure according to change of a distance between the first electrode and the second electrode.

10. The pressure touch detection method of claim 9, wherein the step of detecting the pressure of touch according to change of the distance between the first electrode and the second electrode comprises:
detecting resistance change of the piezoresistive material layer between the first electrode and the frame, calculating pressure data based on the resistance change to determine the touch pressure.
